(19) United States
(12) Patent Application Publication
(10) Pub. No.: US 2025/0358566 A1
(43) Pub. Date: Nov. 20, 2025

(54) SOUND-ABSORBING MATERIAL

(71) Applicant: ROGERS CORPORATION, Chandler, AZ (US)

(72) Inventors: Katherine Vuong, Chicago, IL (US); Kshitish Patankar, Naperville, IL (US); Kenneth A. Mazich, Chicago, IL (US)

(21) Appl. No.: 19/210,167

(22) Filed: May 16, 2025

Related U.S. Application Data
(60) Provisional application No. 63/648,809, filed on May 17, 2024.

(51) Int. Cl. H04R 1/28

(52) U.S. Cl. CPC H04R 1/288

(57) ABSTRACT

A sound-absorbing material including a foam; and sound-absorbing particles fixed directly to surfaces of cells walls in the foam.

### CROSS REFERENCE TO RELATED APPLICATION

This application claims the benefit of U.S. Application No. 63/648,809, filed May 17, 2024, which is incorporated by reference in its entirety herein.

### BACKGROUND

This application is directed to a sound-absorbing material. The sound-absorbing material can be included in an electronic device such as a cellular phone or a personal digital assistant.

A size of a back cavity in a speaker arrangement for sound generation can be limited in small audio devices such as a cellular phone or a personal digital assistant. The size limitation of the cavity can compromise sound quality at low frequencies.

Sound-absorbing particles can be distributed and fixed to surfaces of a framework in the cavity with binders and or adhesives. The framework can be the sides of the cavity or a non-woven web containing the sound-absorbing particles. Apparent volume of the cavity can be effectively increased and low frequency performance of the audio device can be improved. The use of binders, adhesives, or other fixing materials can occlude a fraction of pores of the sound-absorbing particles and compromise the performance of the electronic device.

There is accordingly a need for sound-absorbing materials in which pores of sound-absorbing particles included therein are not occluded and performance of an electronic device including the sound-absorbing material is not compromised.

### SUMMARY

Provided is a sound-absorbing material including a foam; and sound-absorbing particles fixed directly to surfaces of cells walls in the foam.

The sound-absorbing particles can include a zeolite.

The foam can include a silicone foam.

The foam can include a polyurethane foam.

The foam can include open cells.

The foam can include open cells and closed cells.

The sound-absorbing material can include less than 1 weight percent, less than 0.5 weight percent, or less than 0.1 weight percent, of binder, based on a total weight of the sound-absorbing material.

The sound-absorbing material can include 0 weight percent of binder, based on a total weight of the sound-absorbing material.

The sound-absorbing material can include less than 1 weight percent, less than 0.5 weight percent, or less than 0.1 weight percent, of adhesive, based on a total weight of the sound-absorbing material.

The sound-absorbing material can include 0 weight percent of adhesive, based on a total weight of the sound-absorbing material.

An electronic device can include a cavity; and the sound-absorbing material disposed within the cavity.

The electronic device can include a speaker.

Provided is a method of forming a sound-absorbing material including partially curing a curable foam composition to provide a partially cured foam composition; contacting sound-absorbing particles and a surface of the partially cured foam composition to provide an intermediate foam product including the sound-absorbing particles directly on the surface of the partially cured foam composition; and further curing the intermediate foam product to form the sound-absorbing material including a foam and the sound-absorbing particles fixed directly to surfaces of cell walls in the foam.

Contacting the sound-absorbing particles and the surface of the partially cured foam composition can include use of a solvent carrier.

The solvent carrier can include hexamethyl disiloxane.

A method of forming an electronic device can include forming the sound-absorbing material; and disposing the sound-absorbing material within a cavity of the electronic device.

Provided is a method of forming a sound-absorbing material including combining sound-absorbing particles and a solvent carrier to form a solution; and contacting the solution and a surface of a foam composition to form a foam product including the sound-absorbing particles directly on a surface of the foam composition, wherein the sound-absorbing material includes less than 1 weight percent, less than 0.5 weight percent, or less than 0.1 weight percent, of binder, based on a total weight of the sound-absorbing material, and wherein the sound-absorbing material includes less than 1 weight percent, less than 0.5 weight percent, or less than 0.1 weight percent, of adhesive, based on a total weight of the sound-absorbing material.

The method can further include partially curing a curable foam composition to provide a partially cured foam composition; contacting the sound-absorbing particles in the solvent carrier and the surface of the foam composition can include contacting the sound-absorbing particles in the solvent carrier and the surface of the partially cured foam composition; and the method can further include further curing the foam product to form the sound-absorbing material including a foam and the sound-absorbing particles fixed directly to surfaces of cell walls in the foam.

The foam composition can be fully cured.

A method of forming an electronic device can include forming the sound-absorbing material; and disposing the sound-absorbing material within a cavity of the electronic device.

### BRIEF DESCRIPTION OF THE DRAWINGS

The following figures represent exemplary embodiments.

FIG. 1 is an image taken with light microscopy of a tacky silicone foam of the Example before incorporation of zeolite at thirty times magnification;

FIG. 2 is an image taken with light microscopy of a post cured silicone foam of the Example at thirty times magnification; and

FIG. 3 is an image taken with light microscopy of the post cured silicone foam of the Example at one hundred times magnification.

### DETAILED DESCRIPTION

Provided is a sound-absorbing material for inclusion in the cavity of an electronic device. The sound-absorbing material can improve the low frequency performance of the electronic device. The electronic device and cavity thereof can be small and portable, such as a cellular phone or a speaker of a personal digital assistant. The introduction of the sound-absorbing material into the cavity of an audio speaker can enhance the quality of the low frequency sound from small electronic speakers. The introduction of the sound-absorbing material into the cavity of an audio speaker can lower a resonant frequency of the audio speaker, or effectively increase a volume of the cavity.

Sound-absorbing particles are fixed directly to surfaces of cell walls in foam. As used herein, the phrase “fixed directly to” or “fixed directly on” means that the sound-absorbing particles are fixed to (or on) the surfaces of cell walls in the foam with a minimal amount of or no amount of a binder, an adhesive, or a combination thereof. The sound-absorbing particles are physically adsorbed by the foam.

The sound-absorbing material can include less than 1 weight percent (wt %), less than 0.5 wt %, or less than 0.1 wt %, of binder, based on a total weight of the sound-absorbing material. The sound-absorbing material can include 0 wt % of binder, based on a total weight of the sound-absorbing material. The sound-absorbing material can include less than 1 wt %, less than 0.5 wt %, less than 0.1 wt %, of adhesive, based on a total weight of the sound-absorbing material. The sound-absorbing material can include 0 wt % of adhesive, based on a total weight of the sound-absorbing material.

Occlusion of pores of the sound-absorbing particles can be decreased or prevented by using a minimal amount of or no amount of a binder, an adhesive, or a combination thereof to fix the sound-absorbing particles to the surfaces of cell walls in the foam and an open architecture of sound-absorbing particles included in the sound-absorbing material can be maintained. Porosity and accessibility of air (or other cavity gases) to the surfaces of the sound-absorbing particles can be preserved by the open architecture of the sound-absorbing particles. Preventing occlusion of pores of the sound-absorbing particles can increase the effective volume of a cavity in an electronic device audio cavity and decrease resonant frequency of the cavity.

The sound-absorbing particles are fixed to the surfaces of the cell walls in the foam with a minimal amount of or no amount of a binder, an adhesive, or a combination thereof. Fixing of the sound-absorbing particles to the surfaces of the cell walls in the foam can be accomplished by preparing foam that is partially cured, but above the gelation threshold and into the solid phase. The foam can be a solid to preserve a shape of the foam, but partially cured and tacky to accept the sound-absorbing particles. As used herein, a “gelation threshold” or “gel point” of the foam refers to point of chemical conversion from liquid to solid.

Accordingly, a method of forming the disclosed sound-absorbing material can include partially curing a curable foam composition to provide a partially cured foam composition; contacting sound-absorbing particles and a surface of the partially cured foam composition to provide an intermediate foam product including the sound-absorbing particles directly on the surface of the partially cured foam composition; and further curing the intermediate foam product to form the sound-absorbing material including a foam and the sound-absorbing particles fixed directly to surfaces of cell walls in the foam.

The partially cured foam includes a plurality of openings, i.e., pores. The pores are defined by an inner surface of the foam. The partially cured foam can have an average pore size of 250 to 400 micrometers (μm).

The term “foam” as used herein refers to materials having a cellular structure, i.e., a void content. Cell morphology can be characterized, for example, using various microscopy techniques, for example optical microscopy or scanning electron microscopy. The foams can have a thickness of, for example, 1 to 30 millimeters (mm), or 1 to 20 mm, or 1 to 15 mm, or 1 to mm, or 1 to 8 mm, or 1.2 to 8 mm, or 1.5 to 8 mm, or 1.5 to 6 mm, or 2.5 to 6 mm. The foams can have a density of less than 500 kilograms per cubic meter (kg/m³), for example less than 400 kg/m³, or 150 to less than 500 kg/cm³, or 150 to less than 400 kg/cm³, or 150 to less than 350 kg/cm³, or 200 to 335 kg/m³, or 250 to 325 kg/m³. The foam can have a void volume content of 5 to 99%, for example, greater than or equal to 30% (i.e., 30 to 99%), based upon the total volume of the foam.

The cell structure of the foam includes open cells and optionally closed cells, with some degree of connectivity between the cells. Sound-absorbing particles can be imbibed into the foam to various extents by changing wall structure, applying mechanical forces (pressure), or a combination thereof. As used herein, changing wall structure refers to various degrees of open cell structure of the foam, which can help control the amount of sound-absorbing particles, e.g., zeolite, that can be imbibed and where the zeolite will reside in the foam structure. Changing wall structure can include decreasing the thickness of walls or providing asymmetric cells. Greater open cell content may accept a higher amount of sound-absorbing particles. Mechanical pressure can be used to help push or force more zeolite into the foam, or make the imbibing process more efficient. Various cell structures of the foam can also contribute to the effective volume of the cavity by dissipating air flow or deforming under the pressure in the cavity.

At least a portion of the cells are open to a surface of the foam, allowing communication with the surrounding environment. At least a portion of the cells can be interconnected and at least a portion of the cells can be open, allowing passage of air, water, water vapor, or the like from a first outer surface of the foam to an opposite second outer surface of the foam.

The partial curing provides a tacky surface for fixing the sound-absorbing particles to the surfaces of the cell walls in the foam. The sound-absorbing particles can be added to, for example, poured or shaken into, the pores of the foam and stick to the tacky cell walls. A surface of the foam can be skived or otherwise suitably prepared to accept the sound-absorbing particles while imbibing the foam with the sound-absorbing particles. Residual particles can be emptied from the foam, and the sound-absorbing material is subsequently cured to fix the particles to the cell walls in the foam and complete cure of the foam.

Contacting the sound-absorbing particles and the surface of the partially cured foam composition can include use of a solvent carrier. For example, a highly volatile carrier can help introduce the sound-absorbing particles into the foam structure. As used herein, “highly volatile” refers to a solvent that completely or nearly completely vaporizes at ambient temperature and pressure, i.e., no vacuum.

The highly volatile carrier can be a solvent for the cell wall. The highly volatile solvent can swell the foam wall to some degree, providing a better surface for tack and adhesion. The highly volatile solvent can vaporize after swelling and imbibing. For example, hexamethyl disiloxane can be used to disperse sound-absorbing particles into silicone foam and swell the cell walls. Other examples of suitable highly volatile solvents that can be used to disperse the particles on the cell walls include siloxane or organic solvents. Control of the degree of swelling can also provide a tackiness that might better trap the zeolite in place. After imbibing, the sound-absorbing material can be exposed to vacuum conditions or allowed to air dry. The highly volatile character of the carrier, e.g., solvent, can help complete post cure of the sound-absorbing material.

The highly volatile carrier can help carry zeolite into the foam and assist with direct fixing of the zeolite to surfaces of cells walls in the foam. The highly volatile carrier can help swell cell walls in the foam for improved direct fixing of zeolite to the cell walls. The highly volatile carrier is not a polymeric binder and could be removed, e.g., evaporated, during post cure of the sound-absorbing material.

Accordingly, a method of forming the disclosed sound-absorbing material can include combining sound-absorbing particles and a solvent carrier to form a solution and contacting the solution and a surface of a foam composition to form a foam product including the sound-absorbing particles directly on a surface of the foam composition. The sound-absorbing material can include less than 1 wt %, less than 0.5 wt %, or less than 0.1 wt %, of binder, based on a total weight of the sound-absorbing material, and less than 1 wt %, less than 0.5 wt %, less than 0.1 wt %, of adhesive, based on a total weight of the sound-absorbing material.

The method can further include partially curing a curable foam composition to provide a partially cured foam composition. Contacting the sound-absorbing particles in the solvent carrier and the surface of the foam composition can include contacting the sound-absorbing particles in the solvent carrier and the surface of the partially cured foam composition. And the method can further include further curing the foam product to form the sound-absorbing material including a foam and the sound-absorbing particles fixed directly to surfaces of cell walls in the foam.

The foam composition with which the solution including the sound-absorbing particles and the solvent carrier is contacted can be fully cured.

### Sound-Absorbing Particles

The sound-absorbing particles can adsorb and desorb air. The sound-absorbing particles can include a zeolite (for example, a silicon-based zeolite), activated carbon (for example, powdered or granular), or a combination thereof. The sound-absorbing particles can be coupled to each other to form agglomerates.

The sound-absorbing particles can have an average particle size of 1 to 20 μm, for example, 5 to 15 μm. The sound-absorbing particles can have an average pore size of 0.1 to 15 nanometers (nm), for example, 0.2 to 10 nm or 0.25 to 5 nm. The sound-absorbing particles can have a pore diameter of 3 angstrom. The sound-absorbing particles can be present in an amount of 1 to 20 wt %, for example, 5 to 10 wt %, based on a total weight of the sound-absorbing material.

The sound-absorbing particles can include an MFI-structural-type molecular sieve including a framework and an extra-framework cation, the framework including SiO₂ and a metal oxide including a metal element M. The Si/M atom molar ratio in the framework can be between 220 and 600, wherein the metal element M includes aluminum, and the extra-framework cation can be at least one of a hydrogen ion, an alkali metal ion, or an alkaline earth metal. For example, the silicon to aluminum atomic molar ratio in the framework can be between 250 and 500, for example, between 280 and 450.

The MFI-structural-type molecular sieve can include silicon dioxide having uniform micropores that absorb and desorb air molecules under the action of sound pressure, thereby increasing the volume of the virtual acoustic cavity.

The MFI-structural-type molecular sieve can further include an extra-framework cation, which can effectively improve the stability of the molecular sieve, and performance stability of the speaker can be improved.

The metal element M of the framework can further include a trivalent metal ion, a tetravalent metal ion other than aluminum, or a combination thereof. The trivalent metal ion, the tetravalent metal ion, or the combination thereof can include a chromium ion, an iron ion, a gallium ion, a nickel ion, a titanium ion, a zirconium ion, a cerium ion, or a combination thereof.

The molecular sieve can be a pure phase MFI-structural-type molecular sieve. A speaker box filled with the MFI-structural-type molecular sieves in the posterior cavity can have better acoustic performance in the low frequency band. The molecular sieve can also be a mixed phase MFI type molecular sieve containing other hetero-phases such as MEL, BEA, etc.

Other sound-absorbing particles can include, for example, porous silica, fumed silica, carbon black, or a combination thereof. The sound-absorbing particles can include any suitable particles that can trap air, for example, within pores thereof.

The foam is selected to be inert to the ordinary operating conditions of an electronic device and to act as a carrier for the sound-absorbing particles. The foam can have an affinity for the sound-absorbing particles such as tackiness or surface forces. For example, the foam can include a silicone foam or a polyurethane foam.

### Silicone Foam

The silicone foam can include a poly(dialkyl siloxane), for example a poly(dimethyl siloxane).

The silicone foam can be prepared from a curable composition including an alkenyl-containing component. The alkenyl-containing component can include an alkenyl-diterminated polyorganosiloxane. The alkenyl-diterminated polyorganosiloxane can be represented by the formula:

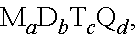

wherein the subscripts a, b, c, and d are zero or a positive integer, subject to the limitation that if subscripts a and b are both equal to zero, subscript c is greater than or equal to two; M has the formula R₃SiO_{1/2}; D has the formula R₂SiO_{2/2}; T has the formula RSiO_{3/2}; and Q has the formula SiO_{4/2}, wherein each R group independently represents hydrogen, terminally-substituted C₁₋₆ alkenyl groups, substituted and unsubstituted monovalent hydrocarbon groups having from 1 to 40, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group is bonded at the molecular chain terminals, i.e., an alkenyl-terminated polyorganosiloxane. As used herein, an alkenyl-diterminated polyorganosiloxane refers to a polyorganosiloxane wherein two of the chain ends are alkenyl groups. The alkenyl-diterminated polyorganosiloxane can be a vinyl-diterminated polyorganosiloxane. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the alkenyl-terminated polyorganosiloxane can be, for example 0.001 to 3 wt %, or 0.01 to 0.5 wt %, or 0.01 to 0.15 wt %, or 0.01 to 0.1 wt %.

Other silicon-bonded organic groups in the alkenyl-terminated polyorganosiloxane, when present, are exemplified by substituted and unsubstituted monovalent hydrocarbon groups having from one to forty carbon atoms, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically useful.

The alkenyl-diterminated polyorganosiloxane can have straight chain, partially branched straight chain, branched-chain, or a network molecular structure, or can be a mixture of such structures. The alkenyl-diterminated polyorganosiloxane is exemplified by vinyl-endblocked polydimethylsiloxanes; vinyl-endblocked dimethylsiloxane-diphenylsiloxane copolymers; vinyl-endblocked dimethylsiloxane-methylphenylsiloxane copolymers; vinyl-endblocked dimethylsiloxane-methylphenylsiloxane-diphenylsiloxane copolymers; vinyl-endblocked dimethylsiloxane-methylphenylsiloxane copolymers; vinyl dimethylsiloxane-methylvinylsiloxane copolymers; vinyl-endblocked methylvinylsiloxane-methylphenylsiloxane copolymers; vinyl-endblocked dimethylsiloxane-methylvinylsiloxane-methylphenylsiloxane copolymers; dimethylvinylsiloxy-endblocked methylvinylpolysiloxanes; dimethylvinylsiloxy-endblocked methylvinylphenylsiloxanes; dimethylvinylsiloxy-endblocked dimethylvinylsiloxane-methylvinylsiloxane copolymers; dimethylvinylsiloxy-endblocked dimethylsiloxane-methylphenylsiloxane copolymers; dimethylvinylsiloxy-endblocked dimethylsiloxane-diphenylsiloxane copolymers; or a combination thereof. The alkenyl-diterminated polyorganosiloxane can include a vinyl-diterminated polydimethylsiloxane.

The alkenyl-diterminated polyorganosiloxane can have a viscosity of 100 to 150,000 centipoise (cP). The alkenyl-diterminated polyorganosiloxane can have a viscosity of greater than 10,000 cP, for example, 10,000 to 150,000 cP, or 50,000 to 150,000 cP. The alkenyl-diterminated polyorganosiloxane can include a vinyl-diterminated polydimethysiloxane having a viscosity of greater than 10,000 cP, for example, 10,000 to 150,000 cP, or 50,000 to 150,000 cP.

The alkenyl-diterminated polyorganosiloxane can include more than one alkenyl-diterminated polyorganosiloxane, for example at least two alkenyl-diterminated polyorganosiloxanes. The alkenyl-diterminated polyorganosiloxane can include a first alkenyl-diterminated polyorganosiloxane having a viscosity of greater than 10,000 cP, for example, 10,000 to 150,000 cP, or 50,000 to 150,000 cP, and a second alkenyl-diterminated polyorganosiloxane having a viscosity of greater than 10,000 cP, for example, greater than 10,000 to 150,000 cP, or 50,000 to 150,000 cP. The first alkenyl-diterminated polyorganosiloxane can be a first vinyl-diterminated polydimethysiloxane, for example, a first vinyl-diterminated polydimethylsiloxane. The second alkenyl-diterminated polyorganosiloxane can be a second vinyl-diterminated polydimethysiloxane, for example, a second vinyl-diterminated polydimethylsiloxane.

The alkenyl-diterminated polyorganosiloxane can be present in the curable composition for forming the silicone foam (hereinafter “curable composition”) in an amount of 30 to 99.9 wt %, based on the total weight of the curable composition. Within this range, the alkenyl-diterminated polyorganosiloxane can be present in the curable composition in an amount of 30 to 90 wt %, or 30 to 70 wt %, or 35 to 68 wt %, or 35 to 65 wt %, or 38 to 65 wt %, or 40 to 45 wt %, each based on the total weight of the curable composition.

The alkenyl-containing component of the curable composition can optionally further include an alkenyl-substituted MDQ polyorganosiloxane. As used herein, “MDQ polyorganosiloxane” refers to a polyorganosiloxane represented by the formula:

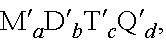

wherein the subscripts a, b, and d are each a positive integer and c is zero or a positive integer; M′ has the formula R₃SiO_{1/2}; D′ has the formula R₂SiO_{2/2}; T′ has the formula RSiO_{3/2}; and Q′ has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group can be bonded at the molecular chain terminals, in pendant positions on the molecular chain, or both. The alkenyl-substituted MDQ polyorganosiloxane can be a vinyl-substituted MDQ polyorganosiloxane.

The alkenyl-substituted MDQ polyorganosiloxane can have an alkenyl content (e.g., a vinyl content) of 1 to 2.5 weight percent, or 2 to 2.5 weight percent, each based on the total weight of the MDQ polyorganosiloxane.

The alkenyl-substituted MDQ polyorganosiloxane can have a viscosity of greater than 500 cP, for example greater than 1,000 cP, or greater than 5,000 cP, or greater than 10,000 cP. The alkenyl-substituted MDQ polyorganosiloxane can have a viscosity of 5,000 to 20,000 cP, or 10,000 to 20,000 cP. Combinations of more than one MDQ polyorganosiloxanes are also contemplated.

The MDQ polyorganosiloxane can be provided in the form of a blend with a carrier fluid. Exemplary carrier fluids can include a polyorganosiloxane, for example, including an alkenyl-diterminated polyorganosiloxane. The alkenyl-diterminated polyorganosiloxane can be as described above, and can be the same or different from the above-described alkenyl-diterminated polyorganosiloxane. The alkenyl-substituted MDQ can be provided in a carrier fluid including a third polyorganosiloxane including an alkenyl-diterminated polyorganosiloxane having an alkenyl content of 0.01 to 0.5 weight percent, and a number average molecular weight of 25,000 to 35,000 grams per mole, 65,000 to 75,000 grams per mole, or a combination thereof.

The MDQ polyorganosiloxane can be present in the curable composition in an amount of 0.5 to 25 weight percent, based on the total weight of the curable composition. Within this range, the MDQ polyorganosiloxane can be present in the curable composition in an amount of 1 to 20 weight percent, or 2 to 18 weight percent, or 5 to 15 weight percent, or 8 to 13 weight percent, each based on the total weight of the curable composition.

The alkenyl-containing component of the curable composition can include a mono-alkenyl terminated polyorganosiloxane. Suitable mono-alkenyl terminated polyorganosiloxanes can be represented by the formula:

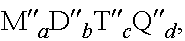

wherein the subscripts a, b, c, and d are zero or a positive integer, subject to the limitation that if subscripts a and b are both equal to zero, subscript c is greater than or equal to two; M″ has the formula R₃SiO_{1/2}; D″ has the formula R₂SiO_{2/2}; T″ has the formula RSiO_{3/2}; and Q″ has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. In a mono-alkenyl terminated polyorganosiloxane, only one chain end of the polyorganosiloxane includes an alkenyl group. The mono-alkenyl terminated polyorganosiloxane includes a mono-vinyl terminated polyorganosiloxane, wherein a vinyl group is a group having the formula —CH═CH₂, and a “substituted vinyl group” has the formula —CH═CR₂, where the R groups can be independently hydrogen or C₁₋₆ alkyl groups. The vinyl concentration in the mono-alkenyl-terminated polyorganosiloxane can be, for example 0.001 to 1 weight percent, or 0.01 to 0.5 weight percent, or 0.01 to 0.25 weight percent, or 0.05 to 0.2 weight percent, each based on the total weight of the mono-alkenyl-terminated polyorganosiloxane. The mono-alkenyl-terminated polyorganosiloxane can have a viscosity of less than 1,000 cP, preferably 100 to 750 cP.

When present, the mono-alkenyl-terminated polyorganosiloxane can be included in the curable composition in an amount of 0.5 to 5 weight percent, based on the total weight of the curable composition. Within this range, the mono-alkenyl-terminated polyorganosiloxane can be included in the curable composition in an amount of 0.5 to 3 weight percent, or 0.75 to 2.75 weight percent, or 1 to 2.5 weight percent, each based on the total weight of the curable composition.

In addition to the alkenyl-containing component, the curable composition includes a hydride-containing component. The hydride-containing component can include a hydride-substituted polyorganosiloxane.

The hydride-substituted polyorganosiloxane can have at least two silicon-bonded hydrogen atoms per molecule, and is generally represented by the formula:

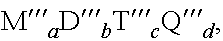

wherein the subscripts a, b, c, and d are zero or a positive integer, subject to the limitation that if subscripts a and b are both equal to zero, subscript c is greater than or equal to two; M′″ has the formula R₃SiO_{1/2}; D′″ has the formula R₂SiO₂₁; T′″ has the formula RSiO_{3/2}; and Q′″ has the formula SiO_{4/2}, wherein each R group independently represents hydrogen, substituted and unsubstituted monovalent hydrocarbon groups having from one to forty, or one to six carbon atoms each, subject to the limitation that at least two of the R groups are hydrogen. For example, each of the R groups of the polyorganosiloxane having at least two silicon-bonded hydrogen atoms per molecule are independently selected from hydrogen, methyl, ethyl, propyl, butyl, pentyl, hexyl, aryl, phenyl, tolyl, xylyl, aralkyl, benzyl, phenethyl, halogenated alkyl, 3-chloropropyl, 3,3,3-trifluoropropyl, or a combination thereof. Methyl and phenyl can be preferred.

The hydrogen can be bonded to silicon at the molecular chain terminals, in pendant positions on the molecular chain, or both. The hydrogens can be substituted at terminal positions. At least 3 to 4 hydrogens can be present per molecule. The hydrogen-containing polyorganosiloxane component can have straight chain, partially branched straight chain, branched-chain, cyclic, or network molecular structure, or can be a mixture of two or more different polyorganosiloxanes with the exemplified molecular structures.

The hydride-containing polyorganosiloxane can include, for example, trimethylsiloxy-endblocked methylhydrogenpolysiloxanes; trimethylsiloxy-endblocked dimethylsiloxane-methylhydrogensiloxane copolymers; trimethylsiloxy-endblocked methylhydrogensiloxane-methylphenylsiloxane copolymers; trimethylsiloxy-endblocked dimethylsiloxane-methylhydrogensiloxane-methylphenylsiloxane copolymers; dimethylhydrogensiloxy-endblocked dimethylpolysiloxanes; dimethylhydrogensiloxy-endblocked methylhydrogenpolysiloxanes; dimethylhydrogensiloxy-endblocked dimethylsiloxanes-methylhydrogensiloxane copolymers; dimethylhydrogensiloxy-endblocked dimethylsiloxane-methylphenylsiloxane copolymers; and dimethylhydrogensiloxy-endblocked methylphenylpolysiloxanes. The hydride-substituted polyorganosiloxane can include a trimethylsiloxy-endblocked methylhydrogenpolysiloxane.

The silicone hydride-containing component can include silicon-bonded hydrogen atoms and an alkenyl group. The alkenyl group can be a vinyl group, and can be positioned at a chain end of the silicon-hydride containing component.

The silicone hydride-containing component can have a hydride content ranging from 0.01 to 10 percent by weight and a viscosity ranging from 10 to 10,000 centipoise at 25° C. The hydride-substituted polyorganosiloxane can include a trimethylsiloxy-endblocked methylhydrogenpolysiloxane having a hydride content of 0.1 to 5 wt %, or 0.5 to 2 wt %, or 1 to 2 wt %. The hydride-substituted polyorganosiloxane can include a trimethylsiloxy-endblocked methylhydrogenpolysiloxane having a viscosity of 10 to 50 cP, or 10 to 30 cP, or 15 to 30 cP, or 20 to 30 cP. The hydride-substituted polyorganosiloxane can include a trimethylsiloxy-endblocked methylhydrogenpolysiloxane having a hydride content of 0.1 to 5 wt %, or 0.5 to 2 wt %, or 1 to 2 wt % and a viscosity of 10 to 50 cP, or 10 to 30 cP, or 15 to 30 cP, or 20 to 30 cP.

Combinations of hydride-containing polyorganosiloxanes are also contemplated by the present disclosure.

The hydride-substituted polyorganosiloxane component is used in an amount sufficient to cure the composition. For example, the alkenyl-containing component and the hydride-containing component can be present in a weight ratio of alkenyl-containing component:hydride-containing component of 8:1 to 40:1, or 10:1 to 40:1, or 13:1 to 40:1, or 8:1 to 25:1, or 13:1 to 25:1, or 8:1 to 20:1, or 13:1 to 20:1. The hydride-substituted polyorganosiloxane component can be used in a quantity that provides a molar ratio of hydride groups to a sum of vinyl and hydroxyl groups of 1.1 to 2.5, or 1.1 to 1.5.

The hydride-substituted polyorganosiloxane component can be provided with a carrier fluid. The carrier fluid can be a polyorganosiloxane, for example having the structure

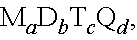

wherein M, D, T, Q and the subscripts a, b, c, and d are as previously defined. The carrier fluid can include a second alkenyl-terminated polyorganosiloxane, which can be the same or different from the alkenyl-terminated polyorganosiloxane described previously. For example, the second alkenyl-terminated polyorganosiloxane can be different from the alkenyl-terminated polyorganosiloxane described previously in chemical composition, viscosity, or both. The second alkenyl-terminated polyorganosiloxane can be different from the alkenyl-terminated polyorganosiloxane described previously in viscosity. The second alkenyl-terminated polyorganosiloxane can be an alkenyl-diterminated polyorganosiloxane, wherein two of the chain ends are alkenyl groups. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the second alkenyl-terminated polyorganosiloxane can be, for example 0.001 to 1 wt %, or 0.01 to 0.5 wt %, or 0.01 to 0.15 wt %, or 0.01 to 0.1 wt %.

The carrier fluid can include a second alkenyl-terminated polyorganosiloxane having a viscosity of greater than 500 cP, for example greater than 1,000 cP, or greater than 5,000 cP. The second alkenyl-terminated polyorganosiloxane can have a viscosity of 500 to 10,000 cP.

When included in a carrier fluid, the hydride-substituted polyorganosiloxane component can be present in the carrier fluid in a weight ratio of 10:90 to 90:10, or 50:50 to 85:15, or 60:40 to 70:30.

In addition to the alkenyl-containing component and the hydride-containing component, the curable composition can further optionally include a cure catalyst, a blowing agent, an inhibitor, or a combination thereof.

The cure catalyst can be a hydrosilylation-reaction catalyst. Effective catalysts promote the addition of silicon-bonded hydrogen onto alkenyl multiple bonds to accelerate cure. Such catalyst can include a noble metal, such as, for example, platinum, rhodium, palladium, ruthenium, iridium, or a combination thereof. The catalyst can also include a support material, such as activated carbon, aluminum oxide, silicon dioxide, polymer resin, or a combination thereof.

The cure catalyst can be present in amounts of up to 1,000 parts per million by weight (ppmw) of metal (e.g., platinum). The cure catalyst can be present in an amount of 1 to 500 ppmw, or 1 to 250 ppmw, or 1 to 100 ppmw, or 1 to 50 ppmw, or 5 to 50 ppmw, or 10 to 50 ppmw.

Platinum and platinum-containing compounds can be preferred, and include, for example platinum black, platinum-on-alumina powder, platinum-on-silica powder, platinum-on-carbon powder, chloroplatinic acid, alcohol solutions of chloroplatinic acid platinum-olefin complexes, platinum-alkenylsiloxane complexes and the catalysts afforded by the microparticulation of the dispersion of the catalyst in a polymer resin such as methyl methacrylate, polycarbonate, polystyrene, silicone, and the like. A combination of different catalysts can also be used. When a platinum catalyzed system is used, poisoning of the catalyst can occur, which can cause formation of an uncured or poorly cured silicone composition that is low in strength. Additional platinum can be added, but when a large amount of platinum is added to improve cure, the pot life or working time can be adversely affected. Methyl vinyl (M^{vi}M^{vi}) components can be used as a cure retardant, for example DOWSIL™ 1-2287 Cure Inhibitor from Dow Corning. Such materials bind the platinum at room temperature to prevent cure and hence, improve the working time, but release the platinum at higher temperatures to affect cure in the required period of time. The level of platinum and cure retardant can be adjusted to alter cure time and working time/pot life. When a higher platinum level is used, it is typically less than or equal to 100 ppmw, based on a total weight of the curable polyorganosiloxane composition. Within this range, the additional platinum concentration (i.e., the amount over that required) can be greater than or equal to 50 ppmw, or greater than or equal to 60 ppmw, based on the total weight of the curable composition. Also within this range, the additional platinum concentration can be less than or equal to 90 ppmw, or less than or equal to 80 ppmw, based on a total weight of the curable composition.

The cure retardant concentration (if a cure retardant is used) is less than or equal to 0.3 wt % of the total curable polyorganosiloxane composition. Within this range, the cure retardant concentration is greater than or equal to 0.005 wt %, or greater than or equal to 0.025 wt % based on the total weight of the curable polyorganosiloxane composition. Also within this range, the cure retardant concentration is less than or equal to 0.2 wt %, or less than or equal to 0.1 wt %, based on the total weight of curable composition and the required working time or pot life.

The curable composition can further include a blowing agent. The blowing agent can include a chemical blowing agent. The blowing agent can include water, a silanol-terminated polyorganosiloxane, and a C₁₋₁₂ monoalcohol (which includes diols, triols, carbinols, and the like). The silanol-terminated polyorganosiloxane can have a viscosity of 20 to 40,000 cP, or 400 to 2,000 cP, or 500 to 1,000 cP. The silanol-terminated polyorganosiloxane can include hydroxyl-terminated polydimethylsiloxane. The alcohol can include a C₁₋₆ alcohol. The alcohol can include 1-butanol. The alcohol may consist of a monoalcohol.

Suitable blowing agents can also include physical blowing agents. These blowing agents can be chosen from a broad range of materials, including hydrocarbons, ethers, esters and partially halogenated hydrocarbons, ethers and esters, or the like. Examples of physical blowing agents have a boiling point from −50 to 100° C., or from −50 to 50° C. Exemplary hydrocarbon and substituted (e.g., halogenated hydrocarbons) can include, for example, HCFC's (halo chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the HFCs (halo fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, (Z)-1,1,1,4,4,4-hexafluoro-2-butene, and pentafluoroethane; the HFE's (halo fluoroethers) such as methyl-1,1,1-trifluoroethylether and difluoromethyl-1,1,1-trifluoroethylether; and the hydrocarbons such as n-pentane, isopentane, and cyclopentane. The blowing agent can include carbon dioxide, nitrogen, argon, water, air, nitrogen, and inert gases (such as helium and argon), as well as combinations thereof. The blowing agent can include carbon dioxide, for example solid carbon dioxide (i.e., dry ice), liquid carbon dioxide, gaseous carbon dioxide, or supercritical carbon dioxide.

The blowing agent can be present in the curable composition in a total amount of 0.16 to 2 wt %, or 0.5 to 2 wt %, based on the total weight of the curable composition. The blowing agent can include a chemical blowing agent, and the chemical blowing agent can be present in the curable composition in a total amount of 0.16 to 2 wt %, or 0.5 to 2 wt %, based on the total weight of the curable composition. Water can be included in an amount of 0.01 to 1 wt %, based on the total weight of the curable composition. The silanol-terminated polyorganosiloxane can be present in an amount of 0.1 to 1 wt %, based on the total weight of the curable composition. The C₁₋₁₂ monoalcohol can be present in an amount of 0.05 to 0.5 wt %, based on the total weight of the curable composition.

The curable composition can optionally further include an inhibitor. Inhibitors suitable for use in the curable composition can include alkenyl-diterminated polyorganosiloxanes which can be represented by the formula:

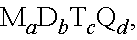

as discussed herein. The function as an inhibitor, the alkenyl-diterminated polyorganosiloxane inhibitor can have a vinyl content of greater than or equal to 15 wt % (based on the total weight of the alkenyl-diterminated polyorganosiloxane inhibitor), a molecular weight of less than 500 grams per mole (g/mol), or both. The inhibitor can be present and include an alkenyl-diterminated polyorganosiloxane having have a vinyl content of greater than or equal to 15 wt %, for example 15 to 40 wt %, or 20 to 40 wt %, or 25 to 35 wt %, and a molecular weight of less than 500 g/mol, for example 50 to 450 g/mol, or 100 to 400 g/mol, or 100 to 250 g/mol.

When present, the inhibitor can be included in the curable composition in an amount of 0.05 to 0.5 wt %, based on a total weight of the alkenyl-containing component and the hydride-containing component in the curable composition.

Other additives can be present in either part of the curable compositions (as discussed herein), for example, an ultraviolet (UV) stabilizer, antistatic agent, dye, pigment, antimicrobial or antiviral agent, and the like, or a combination thereof. When additives are present, the amounts used are selected so that the desired properties of the cured silicone composition are not adversely affected by the presence of the additives.

The curable composition for preparing the silicone foam can include the alkenyl-containing component and the hydride-containing component. The curable composition for preparing the silicone foam can further include a cure catalyst and a blowing agent. Each component can be as described herein and present in amounts described herein.

The curable silicone composition can be manufactured by combining the various components in any suitable order. The curable composition can be provided as a first part and a second part. The first part can include the alkenyl-containing component, and the second part can include the hydride-containing component. The first part can further include the cure catalyst, the blowing agent, the inhibitor, or a combination thereof. The first part and the second part can be mixed, metered, or cast, for example into a mold or on a continuous coating line, to provide the corresponding cured material. Curing and foaming can then occur either in the mold or on the continuous coating line.

The alkenyl-containing component and the hydride-containing component can be present in the curable composition in amounts effective to provide a weight ratio of alkenyl-containing component:hydride-containing component of 10:1 to 40:1, or 13:1 to 40:1, or 13:1 to 25:1, or 13:1 to 20:1. The curable composition can include a molar ratio of hydride groups to a sum of alkenyl and hydroxyl groups of 1.1:1 to 2.5:1, or 1.1:1 to 2:1, or 1.1:1 to 1.5:1.

Other components not specifically described herein can be minimized (i.e., present in an amount of less than or equal to 5 wt %, or less than or equal to 1 wt %, or less than or equal to 0.5 wt %, or less than or equal to 0.1 wt %, or less than or equal to 0.01 wt %, each based on the total weight of the curable composition) or excluded from the curable composition and the cured products (e.g., silicone foams) prepared form the curable compositions. For example, the curable composition can optionally minimize or exclude polymers other that the various polyorganosiloxanes described herein. The curable composition can optionally minimize or exclude surfactants such as fluorinated surfactants. The curable composition or the process of manufacturing the silicone foams described herein can optionally minimize or exclude physical blowing agents.

The curable silicone composition can be poured or injected into a mold and cure and foaming reaction of the curable composition can be conducted at ambient or elevated temperature. The cure can be a partial cure, forming the partially cured foam composition with which the sound-absorbing particles are contacted. Formation of the partially cured foam composition can include, for example, molding, overmolding, injection molding, or reaction injection molding.

A cured silicone foam layer can be formed by casting the curable composition followed by curing the cast composition. Post-cure can be used to advance cure to near complete status, developing desirable physical properties. The cured silicone foams described herein are considered as free-standing silicone foams. Free-standing as used herein means that no supporting layers are present. Thus, any discussion of particular properties associated with the cured silicone foams according to the present disclosure will be understood to refer to the properties of the silicone foam layer itself, in the absence of any supporting layers.

Liquid material inputs of the curable composition can be mixed and cast onto a moving release layer. Another release layer can be pulled through on top of the cast mixture and the sandwiched mixture is then passed through the nip of two rotating rollers to meter the amount of the curable composition, which determines the thickness of the partially cured foam, and ultimately, the final foam. The gap thickness between the rolls (i.e., the nip gap) can be adjusted to decrease the thickness of the sandwiched mixture as it passes between them. The nip gap can be, for example, 0.005 to 0.5 inch (0.127 to 12.7 mm), or 0.01 to 0.1 inches (0.254 to 2.54 mm), or 0.01 to 0.05 inches (0.254 to 1.27 mm), or 0.02 to 0.04 inches (0.508 to 1.016 mm). During the metering step, the width of the sandwiched mixture can be maintained, but the length of the sandwiched mixture can increase as the thickness decreases. In another aspect, a second release layer on top of the cast mixture and rollers are not used, and a process such as knife-over-roll can be used to determine the thickness of the partially cured foam, and ultimately, the final foam.

The coated release layer passes through an oven, which can be heated by at least one platen, by heated air, other means, or a combination thereof to foam and at least partially cure the cast composition. Two or more curing ovens at the same or different temperatures can be used. Temperatures in the oven(s) can be 80 to 200° F. (43.3 to 60° C.) and residence time for the coated carrier in the oven(s) can be varied to achieve the desired level of cure. Upon exiting the oven, when an additional top layer of carrier film is used, the additional top layer can be removed.

It has been found that only certain carriers provide adequate adhesion to the release layer. A suitable carrier for use with the above-described cure conditions is a polyester (such as polyethylene terephthalate, polyethylene naphthalate, polybutylene terephthalate, or polybutylene naphthalate). Polyethylene terephthalate is preferred. It can be possible to adjust processing conditions to achieve effective adhesion with other release layers, for example polyolefin (such as polyethylene, polypropylene, or ethylene-propylene copolymer), polyvinyl alcohol, polyvinylidene chloride, polyvinyl chloride, vinyl chloride-vinyl acetate copolymer, polyvinyl acetate, polyamide, polyimide, cellulose, fluorinated resin, polyether, polystyrene resin (such as polystyrene), polycarbonate, polyether sulfone, or a combination thereof. The substrate can include polyethylene terephthalate.

The silicone foam can be rolled on a drum for storage and optional heating/post-curing, for example at a temperature of 100 to 300° F. (65.6 to 121.1° C.) for 6 to 48 hours. Post-cure is especially useful to lower compression set, eliminate volatile compounds, and complete cure if needed.

### Polyurethane Foam

A method of forming a cured polyurethane foam includes combining an active hydrogen-containing component (also referred to herein as “Part A”) including a polyol and an isocyanate component (also referred to herein as “Part B”) including a polyisocyanate to form an uncured polyurethane foam; and curing the uncured polyurethane foam to form the cured polyurethane foam.

Polyurethane foams can be formed from a reactive composition including an organic isocyanate-containing component reactive with an active hydrogen-containing composition, a surfactant, and a catalyst. Each of the organic isocyanate component and the active hydrogen-containing component can include one or more different types of each type of compound.

The organic polyisocyanate component used in the preparation of polyurethane foams includes at least a polyisocyanate having the general formula Q(NCO)ᵢ, wherein i is an integer having an average value of two or greater, and Q is an organic radical having a valence of i. Q can be a substituted or unsubstituted group (for example, an alkane or an aromatic group of the appropriate valency). Q can be a group having the formula Q¹-Z-Q¹ wherein Q¹ is an alkylene or arylene group and Z is —O—, —O-Q¹-S—, —CO—, —S—, —S-Q¹-S—, —SO—, or —SO₂—. Q can represent a polyurethane radical having a valence of i.

Examples of suitable polyisocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, or polymeric isocyanates such as polymethylene polyphenylisocyanate.

The active hydrogen-containing component includes at least one multi-functional active hydrogen containing compound, which can be a polyamine or a polyol, for example a polyether polyol, a polyester polyol, a lower molecular weight polyol, or a combination thereof. Suitable polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, or castor oil polyols. Suitable dicarboxylic acids and derivatives of dicarboxylic acids that are useful for producing polycondensation polyester polyols are aliphatic or cycloaliphatic dicarboxylic acids such as glutaric, adipic, sebacic, fumaric or maleic acids; dimeric acids; aromatic dicarboxylic acids such as phthalic, isophthalic or terephthalic acids; tribasic or higher functional polycarboxylic acids such as pyromellitic acid; as well as anhydrides or second alkyl esters, such as maleic anhydride, phthalic anhydride or dimethyl terephthalate. The polymers of cyclic esters can also be used. The preparation of cyclic ester polymers from at least one cyclic ester monomer is exemplified by U.S. Pat. Nos. 3,021,309 through 3,021,317; 3,169,945; and 2,962,524. Suitable cyclic ester monomers include but are not limited to δ-valerolactone; ∈-caprolactone; zeta-enantholactone; the monoalkyl-valerolactones, e.g., the monomethyl-, monoethyl-, and monohexyl-valerolactones. In general the polyester polyol may include a caprolactone-based polyester polyol, an aromatic polyester polyol, an ethylene glycol adipate-based polyol, or a combination thereof. Polyester polyols made from ∈-caprolactones, adipic acid, phthalic anhydride, and terephthalic acid or dimethyl esters of terephthalic acid are generally preferred.

Polyether polyols can be obtained by the chemical addition of alkylene oxides, such as ethylene oxide, propylene oxide, or a combination thereof, to water or polyhydric organic components, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy)methyl]-ethane, 1,1,1-tris[2-hydroxypropoxy)-methyl]propane, diethylene glycol, dipropylene glycol, pentaerythritol, sorbitol, sucrose, lactose, alpha-methylglucoside, alpha-hydroxyalkylglucoside, a novolac polymer, phosphoric acid, benzenephosphoric acid, a polyphosphoric acid such as tripolyphosphoric acid and tetrapolyphosphoric acid, ternary condensation products, and the like. The alkylene oxides used in producing polyoxyalkylene polyols can have 2 to 4 carbon atoms, or 2 to 3 carbon atoms. Exemplary alkylene oxides are propylene oxide and mixtures of propylene oxide with ethylene oxide. Polytetramethylene polyether diol or glycol, and mixture with one or more other polyols, can be specifically mentioned. The polyols listed above can be used per se as the active hydrogen component.

A specific class of polyether polyols is represented generally by the formula R[(OCₙH₂ₙ)_{z}OH]ₐ wherein R is hydrogen or a polyvalent hydrocarbon radical; a is an integer (i.e., 2 to 8) equal to the valence of R, n in each occurrence is an integer from 2 to 4 inclusive (preferably 3) and z in each occurrence is an integer having a value of 2 to 200, preferably 15 to 100. Specifically, the polyether polyol can have the formula R[(OC₄H₈)₂OH]₂, wherein R is a divalent hydrocarbon radical and z in each occurrence is 2 to about 40, specifically 5 to 25.

Another type of active hydrogen-containing material that can be used is a polymer polyol composition obtained by polymerizing ethylenically unsaturated monomers with a polyol as described in U.S. Pat. No. 3,383,351, the disclosure of which is incorporated herein by reference. Suitable monomers for producing such compositions include acrylonitrile, vinyl chloride, styrene, butadiene, vinylidene chloride, and other ethylenically unsaturated monomers as identified and described in the above-mentioned U.S. patent. Suitable polyols include those listed and described above and in U.S. Pat. No. 3,383,351. The active hydrogen-containing component may also contain polyhydroxy-containing compounds such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 2,591,884, 2,866,762, 2,850,476, 2,602,783, 2,729,618, 2,779,689, 2,811,493, 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Patent No. 733,624); hydroxyl-terminated polyalkylenearylene ether glycols (U.S. Pat. No. 2,808,391); and hydroxyl-terminated polyalkylene ether triols (U.S. Pat. No. 2,866,774).

The active-hydrogen-containing component, in particular the polyol component, can further include a very low molecular weight chain extender, cross-linking agent, or combination thereof. Exemplary chain extenders and cross-linking agents include alkane diols, dialkylene glycols and/or polyhydric alcohols, preferably triols and tetrols, having a molecular weight from about 200 to 400 Dalton. The chain extenders and cross-linking agents can be used, for example in an amount of 0.5 to 20 percent by weight, or 10 to 15 percent by weight, based on the total weight of the active-hydrogen-containing component. Other chain extenders can be a very low molecular weight (below about 200 Dalton) diol, including but not being limited to, dipropylene glycol, 1,4-butanediol, 2-methyl-1,3-propanediol, and 3-methyl-1,5-pentane diol.

In an embodiment, the active hydrogen-containing component is a polyol component that includes a higher molecular weight polyether polyol, for example a polyether polyol having a weight average molecular weight (Mw) of 500 to about 4,000, or 1,000 and 3,000, and a hydroxy number of 10 to 200; a polyester polyol, such as a polycaprolactone-based polyol, or a combination thereof, and a very low molecular weight polyol as a chain extender or crosslinking agent. Exemplary polyether polyols include polyoxyalkylene diols and triols, and polyoxyalkylene diols and triols with polystyrene and/or polyacrylonitrile grafted onto the polymer chain, or a combination thereof. A triol can be present, such as a polycaprolactone triol having an Mw of 50 to 3,000 and a hydroxy number can be 200 to 2,000, preferably 500 to 1500. A preferred triol is a polycaprolactone triol.

In general, the average weight percent hydroxy, based on the hydroxyl numbers of the hydroxyl-containing compounds (including all polyols or diols), including other cross-linking additives, surfactants, catalysts, and pigments, if used, can be 500 to 400, depending on the desired firmness or softness of the polyurethane. The hydroxyl number is defined as the number of milligrams of potassium hydroxide required for the complete neutralization of the hydrolysis product of the fully acetylated derivative prepared from 1 gram of polyol or polyol component with or without other cross-linking additives.

A number of catalysts can be used to catalyze the reaction of the isocyanate component with the active hydrogen-containing component. The amount of catalyst in the uncured polyurethane foam is 0.001 to 9 wt %, or 0.04 to 9 wt %, or 0.04 to 7 wt %, or 3 to 7 wt %, of catalyst, based on a total weight of the uncured polyurethane foam. Such catalysts include organic and inorganic acid salts of, or organometallic derivatives of bismuth, lead, tin, iron, antimony, uranium, cadmium, cobalt, thorium, aluminum, mercury, zinc, nickel, cerium, molybdenum, vanadium, copper, manganese, or zirconium, as well as phosphines or tertiary organic amines of these metals. Examples of such catalysts are dibutyltin dilaurate, dibutyltin diacetate, stannous octoate, lead octoate, cobalt naphthenate, bis(2,4-pentanedionate) nickel (II) or derivatives thereof such as diacetonitrilediacetylacetonato nickel, diphenylnitrilediacetylacetonato nickel, or bis(triphenylphosphine)diacetyl acetylacetonato nickel. The catalyst can include ferric acetylacetonate, triethylamine, triethylenediamine, N,N,N′,N′-tetramethylethylenediamine, 1,1,3,3-tetramethylguanidine, N,N,N′N′-tetramethyl-1,3-butanediamine, N,N-dimethylethanolamine, N,N-diethylethanolamine, 1,3,5-tris (N,N-dimethylaminopropyl)-s-hexahydrotriazine, o- and p-(dimethylaminomethyl) phenols, 2,4,6-tris(dimethylaminomethyl) phenol, N,N-dimethylcyclohexylamine, pentamethyldiethylenetriamine, 1,4-diazobicyclo [2.2.2] octane, N-hydroxyl-alkyl quaternary ammonium carboxylates and tetramethylammonium formate, tetramethylammonium acetate, or tetramethylammonium 2-ethylhexanoate. A catalyst delay agent can optionally be present, for example as is described in U.S. Pat. Nos. 10,023,681, 9,228,047 and 5,733,945. A combination of at least two different catalysts can be used.

The reactive composition can include a surfactant that can stabilize the reactive composition before it is cured. The surfactant can include an organosilicone surfactant. The organosilicone can include a copolymer including or consisting essentially of SiO₂ (silicate) units and (CH₃)₃SiO_{0.5} (trimethylsiloxy) units in a molar ratio of silicate to trimethylsiloxy units of 0.8:1 to 2.2:1, or 1:1 to 2.0:1. The organosilicone can include a partially cross-linked siloxane-polyoxyalkylene block copolymer, wherein the siloxane blocks and polyoxyalkylene blocks are linked by silicon to carbon, or by silicon to oxygen to carbon. The surfactant can be present in an amount of 0.5 to 10 wt %, or 1 to 6 wt %, based on the total weight of the active hydrogen component. The surfactant is present in an amount of 0.1 to 7 wt %, or 2 to 5 wt %, based on a total weight of the uncured polyurethane foam.

Other, optional additives can be added to the reactive composition. For example, the additive can include a desiccant, dyes, pigments (for example, titanium dioxide or iron oxide), antioxidants, antiozonants, UV stabilizers, or a combination thereof.

Methods for the manufacture of foams are generally known. The foams can be mechanically frothed, physically or chemically blown, or both. The polyurethane foams can be made by casting a mechanically frothed composition. In particular, the reactive precursors of the polyurethane can be mixed and mechanically, frothed, then cast to form a layer, and cured.

Physical blowing agents can be used alone or as mixtures with each other or with one or more chemical blowing agents. Physical blowing agents can be selected from a broad range of materials, including hydrocarbons, ethers, esters and partially halogenated hydrocarbons, ethers, and esters, and the like. Typical physical blowing agents have a boiling point of −50 to 100° C., or −50 to 50° C. Exemplary physical blowing agents include CFC's (chlorofluorocarbons) (for example, 1,1-dichloro-1-fluoroethane, 1,1-dichloro-2,2,2-trifluoro-ethane, monochlorodifluoromethane, or 1-chloro-1,1-difluoroethane); FC's (fluorocarbons) (for example, 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, or pentafluoroethane); FE's (fluoroethers) (for example, methyl-1,1,1-trifluoroethylether or difluoromethyl-1,1,1-trifluoroethylether); or hydrocarbons (for example, n-pentane, isopentane, or cyclopentane). The physical blowing agent can include at least one of carbon dioxide, ethane, propane, n-butane, isobutane, pentane, hexane, butadiene, acetone, methylene chloride, any of the chlorofluorocarbons, hydrochlorofluorocarbons, or hydrofluorocarbons. As with the chemical blowing agents, the physical blowing agents can be used in an amount sufficient to give the resultant foam the desired bulk density. Typically, physical blowing agents are used in an amount of 5 to 50 wt %, or 10 to 30 wt %, based on the total weight of the reactive composition.

If a chemical blowing agent is used, it can include at least one of water, an azo compound (for example, azoisobutyronitrile, azodicarbonamide (i.e. azo-bis-formamide), or barium azodicarboxylate); a substituted hydrazine (for example, diphenylsulfone-3,3′-disulfohydrazide, 4,4′-hydroxy-bis-(benzenesulfohydrazide), trihydrazinotriazine, or aryl-bis-(sulfohydrazide)); a semicarbazide (for example, p-tolylene sulfonyl semicarbazide, or 4,4′-hydroxy-bis-(benzenesulfonyl semicarbazide)); a triazole (for example, 5-morpholyl-1,2,3,4-thiatriazole); an N-nitroso compound (for example, N,N′-dinitrosopentamethylene tetramine or N,N-dimethyl-N,N′-dinitrosophthalmide); benzoxazine (for example, isatoic anhydride); or a mixture (for example, a sodium carbonate/citric acid mixture). The chemical blowing agent can include water. The blowing agent can include at least one of an ammonium salt, a phosphate, a polyphosphate, a borate, a polyborate, a sulphate, a urea, a urea-formaldehyde resin, a dicyandiamide, or a melamine.

The amount of the foregoing chemical blowing agents will vary depending on the agent and the desired foam density, and is readily determinable by one of ordinary skill in the art. In general, these chemical blowing agents are used in an amount of 0.1 to 10 wt %, based on the total weight of the reactive composition. The decomposition products formed during the decomposition process can be physiologically safe, and that may not significantly adversely affect the thermal stability or mechanical properties of the foamed polyurethane.

The polyurethane foam can be produced by mechanically mixing the reactive composition (including the isocyanate component, the active hydrogen-containing component, a froth-stabilizing surfactant, the catalyst, and other optional additives) with a froth-forming gas. The frothed mixture can be fed onto a release liner and spread to a layer of desired thickness by a doctoring blade or other suitable spreading device. The gauged layer of the frothed mixture can then be delivered to one or more heating zones. After the heating zone, the formed polyurethane layer can be passed to a cooling zone.

For example, in the production of polyurethane foams, the reactive components of the polyurethane foam-forming composition can be formulated in two parts, one part (“Part A”) containing the active hydrogen-containing component, the catalyst, the surfactant, and if used the inhibitor, and a chemical blowing agent; and the other part (“Part B”) containing the organic isocyanate component. The parts can be metered, mixed, and cast, for example, into a mold or a continuous coating line. The foaming and curing then occurs either in the mold or on the continuous coating line. In a method of production, the reactive components of the polyurethane foam-forming composition can be introduced into an extruder together with a chemical blowing agent, a physical blowing agent, or other additives if used. The catalyst can then be metered into the extruder to start the foaming and curing reaction. The use of physical blowing agents such as liquid carbon dioxide or supercritical carbon dioxide in conjunction with chemical blowing agents such as water can give rise to foam having much lower densities.

An adhesive layer can be present to adhere a sound-absorbing material including the foam to another sound-absorbing material, another type of layer, or to a component of the electronic device including the sound-absorbing material. A wide variety of suitable adhesives can be used in the sound-absorbing material. The adhesive can be selected for ease of application and stability under the operating conditions of the electronic device. Each adhesive layer can be the same or different, and be of the same or different thickness. Suitable adhesives include a phenolic resin, an epoxy adhesive, a polyester adhesive, a polyvinyl fluoride adhesive, an acrylic or methacrylic adhesive, or a silicone adhesive, for example, an acrylic adhesive or a silicone adhesive. The adhesive can be a silicone adhesive. Solvent-cast, hot-melt, and two-part adhesives can be used. Each of the adhesive layers can independently have a thickness of 0.00025 to 0.010 inches (0.006 to 0.25 mm), or 0.0005 to 0.003 inches (0.01 to 0.08 mm).

When the sound-absorbing material includes an adhesive layer, the sound-absorbing material can further include a release layer. By “release layer” is meant any layer including a release coating, optionally supported by one or more additional layers including a release liner. The thickness of each of the release layers can be 5 to 150 μm, 10 to 125 μm, 20 to 100 μm, 40 to 85 μm, or 50 to 75 μm.

Also provided is an electronic device including a cavity and the disclosed sound-absorbing material disposed within the cavity. The electronic device can include a speaker. A method of forming the electronic device can include forming the sound-absorbing material as disclosed herein and disposing the sound-absorbing material within a cavity of the electronic device.

The following example is provided to illustrate the present disclosure. The example is merely illustrative and is not intended to limit devices made in accordance with the disclosure to the materials, conditions, or process parameters set forth therein.

### EXAMPLE

Materials used in the following example are described in Table 1.

TABLE 1

| Component | Description | Supplier |
|---|---|---|
| Zeolite | 0.3 nanometer pore size, <10 micrometer | |
| | particle size | |
| Vinyl-terminated | Vinyl-terminated polydimethylsiloxane | Elkem |
| PDMS | | |
| MDQ blend-1 | MDQ resin with vinyl-terminated | Momentive |
| | polydimethylsiloxane carrier | |
| MDQ blend-2 | MDQ resin with vinyl-terminated | Momentive |
| | polydimethylsiloxane carrier | |
| Pt Catalyst | [1,3-Bis(2,6-diisopropylphenyl)imidazol-2- | Umicore |
| | ylidene][1,3-divinyl-1,1,3,3- | |
| | tetramethyldisiloxane]platinum(0), obtained as | |
| | Umicore HS245 Pt catalyst solution (10%) | |
| DI water | Deionized Water | |
| ATH | Aluminum trihydrate, obtained as HYDRAL 710 | Huber |
| Mg(OH)₂ | Magnesium hydroxide, obtained as MagShield S | Martin Marietta |
| | | Magnesia |
| | | Specialties, LLC |
| Hydride | Trimethyl terminated MeHSiO siloxane polymer | Elkem |
| Polyorganosiloxane-1 | having pendent hydride groups and a hydride | |
| | content of 1.5 wt %, a viscosity of 25 cP, | |
| | obtained as WR-68 | |
| Hydride | Siloxane polymer having pendent and terminal | Andisil |
| Polyorganosiloxane-2 | hydride groups and a hydride content of 0.86 wt % | |
| | and a viscosity of 50 cP, obtained as XL-1342 | |

### Curable Silicone Foam Composition

A curable silicone foam composition was prepared according to the following general procedure. A first foam precursor mixture (“Part A”) was prepared by adding polyorganosiloxane A, blowing agent (i.e., DI water, BuOH), Pt catalyst, and inhibitor to a mixing cup. The mixture was mixed in a FlackTek speedmixer at 2000 revolutions per minute (rpm) for 30 seconds(s). The mixture was mixed in the speedmixer according to the following protocol: 2100 rpm for 8 s, 2300 rpm for 8 s, 2500 rpm for 10 s, 2650 rpm for 8 s, and 2750 rpm for 8 s. After mixing, the cup was removed and cooled to 40° F. (4.4° C.).

A second foam precursor mixture (“Part B”) was provided including polyorganosiloxane B. The first and second foam precursor mixtures were combined in particular weight ratios to obtain a foam. For example, the first foam precursor mixture and the second foam precursor mixture were combined in the desired weight ratio. The amounts of the components used to prepare the silicone foam for each example are provided in Table 2 in grams (g).

TABLE 2

| | |
|---|---|
| Component | Units |

Part A

| | | |
|---|---|---|
| Vinyl-terminated PDMS | g | 23.94 |
| DI Water | g | 1.6 |
| MDQ blend-1 | g | 98.604 |
| MDQ blend-2 | g | 17.4 |
| Pt Catalyst | g | 0.056 |
| ATH | g | 15 |
| Mg(OH)₂ | g | 45 |
| Part A Total | g | 201.6 |

Part B

| | | |
|---|---|---|
| Hydride Polyorganosiloxane-1 | g | 11.52 |
| Hydride Polyorganosiloxane-2 | g | 1.28 |
| Part B Total | g | 12.4 |

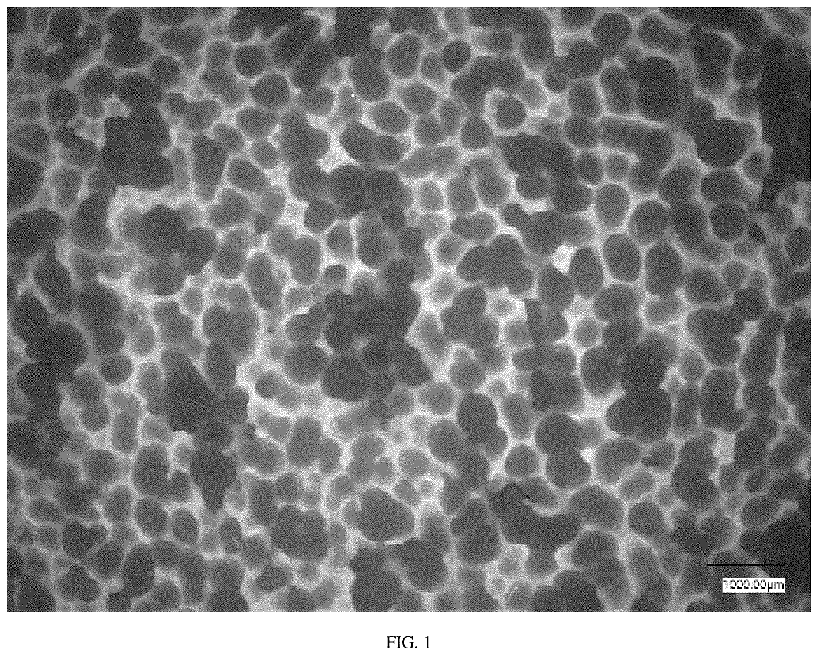

An amount of 250 g of the mixture was poured into a 32 ounce cup mold and allowed to foam and cure at ambient conditions for approximately half an hour or until 3× expansion in height was achieved. The partially cured, tacky foam was then demolded and allowed to free-rise at ambient conditions for an additional half hour to continue expansion in the length and width by 2%. The silicone foam was thus in a solidified state, but remained slightly under-cured. At this stage, the silicone foam was skived to remove the outermost skin layer of 1 millimeter (mm) and to a desired thickness of 1 inch (2.54 centimeters). FIG. 1 is an image taken with light microscopy of a tacky silicone foam of the Example after skiving and before incorporation of zeolite at thirty times magnification;

While the silicone foam was still tacky, zeolites were introduced into the silicone foam and shaken until no additional zeolite particles were accepted onto the cell walls. Excess zeolites were shaken/dusted off, resulting in about 7 weight percent zeolites, based on a total weight of the silicone foam and zeolites.

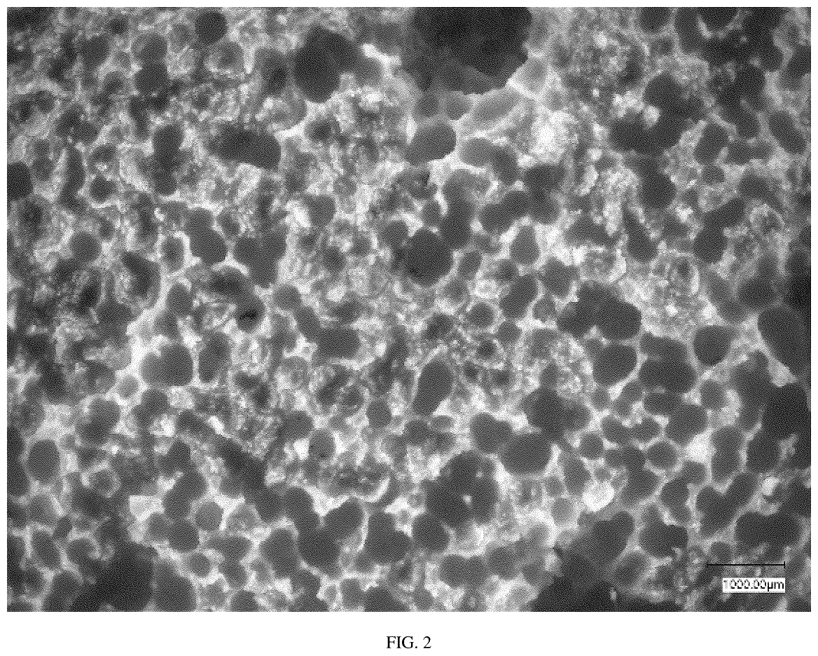

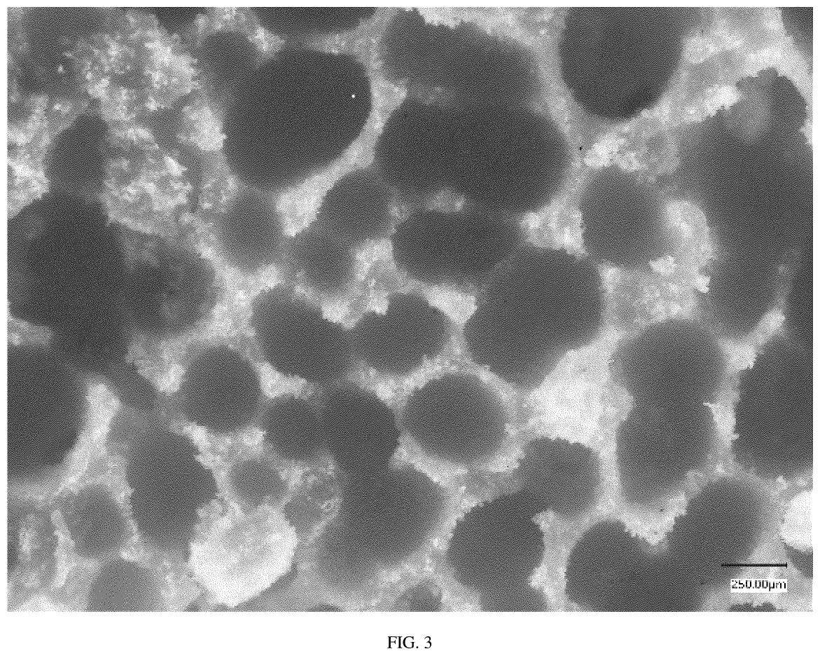

The silicone foam was subsequently post cured at 100° C. for 5 hours to finish crosslinking. FIG. 2 is an image taken with light microscopy of the post cured silicone foam at thirty times magnification and FIG. 3 is an image taken with light microscopy of the post cured silicone foam at one hundred times magnification. Focusing on the wall of the foam in FIG. 2 and FIG. 3, the attachment of zeolites can be seen, compared to the smooth wall surfaces of FIG. 1 (i.e., prior to imbibing the zeolites).

This disclosure further encompasses the following aspects.

Aspect 1: A sound-absorbing material comprising: a foam; and sound-absorbing particles fixed directly to surfaces of cells walls in the foam.

Aspect 2: The sound-absorbing material of aspect 1, wherein the sound-absorbing particles comprise a zeolite.

Aspect 3: The sound-absorbing material of aspect 1 or 2, wherein the foam comprises a silicone foam.

Aspect 4: The sound-absorbing material of aspect 1 or 2, wherein the foam comprises a polyurethane foam.

Aspect 5: The sound-absorbing material of any one of the preceding aspects, wherein the foam comprises open cells.

Aspect 6: The sound-absorbing material of any one of the preceding aspects, wherein the foam comprises open cells and closed cells.

Aspect 7: The sound-absorbing material of any one of the preceding aspects, wherein the sound-absorbing material comprises less than 1 weight percent, less than 0.5 weight percent, or less than 0.1 weight percent, of binder, based on a total weight of the sound-absorbing material.

Aspect 8: The sound-absorbing material of any one of the preceding aspects, wherein the sound-absorbing material comprises 0 weight percent of binder, based on a total weight of the sound-absorbing material.

Aspect 9: The sound-absorbing material of any one of the preceding aspects, wherein the sound-absorbing material comprises less than 1 weight percent, less than 0.5 weight percent, or less than 0.1 weight percent, of adhesive, based on a total weight of the sound-absorbing material.

Aspect 10: The sound-absorbing material of any one of the preceding aspects, wherein the sound-absorbing material comprises 0 weight percent of adhesive, based on a total weight of the sound-absorbing material.

Aspect 11: An electronic device comprising: a cavity; and the sound-absorbing material of any one of the preceding aspects disposed within the cavity.

Aspect 12: The electronic device of aspect 11, wherein the electronic device comprises a speaker.

Aspect 13: A method of forming a sound-absorbing material comprising: partially curing a curable foam composition to provide a partially cured foam composition; contacting sound-absorbing particles and a surface of the partially cured foam composition to provide an intermediate foam product comprising the sound-absorbing particles directly on the surface of the partially cured foam composition; and further curing the intermediate foam product to form the sound-absorbing material comprising a foam and the sound-absorbing particles fixed directly to surfaces of cell walls in the foam.

Aspect 14: The method of aspect 13, wherein contacting the sound-absorbing particles and the surface of the partially cured foam composition comprises use of a solvent carrier.

Aspect 15: The method of aspect 14, wherein the solvent carrier comprises hexamethyl disiloxane.

Aspect 16: A method of forming an electronic device comprising: forming a sound-absorbing material according to the method of any one of aspects 13 to 15; and disposing the sound-absorbing material within a cavity of the electronic device.

Aspect 17: A method of forming a sound-absorbing material comprising: combining sound-absorbing particles and a solvent carrier to form a solution; and contacting the solution and a surface of a foam composition to form a foam product comprising the sound-absorbing particles directly on a surface of the foam composition, wherein the sound-absorbing material comprises less than 1 weight percent, less than 0.5 weight percent, or less than 0.1 weight percent, of binder, based on a total weight of the sound-absorbing material, and wherein the sound-absorbing material comprises less than 1 weight percent, less than 0.5 weight percent, or less than 0.1 weight percent, of adhesive, based on a total weight of the sound-absorbing material.

Aspect 18: The method of aspect 17, wherein: the method further comprises partially curing a curable foam composition to provide a partially cured foam composition; contacting the sound-absorbing particles in the solvent carrier and the surface of the foam composition comprises contacting the sound-absorbing particles in the solvent carrier and the surface of the partially cured foam composition; and the method further comprises further curing the foam product to form the sound-absorbing material comprising a foam and the sound-absorbing particles fixed directly to surfaces of cell walls in the foam.

Aspect 19: The method of aspect 17, wherein the foam composition is fully cured.

Aspect 20: A method of forming an electronic device comprising: forming a sound-absorbing material according to the method of any one of aspects 17 to 19; and disposing the sound-absorbing material within a cavity of the electronic device.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

It will be understood that when an element is referred to as being “on” another element, it can be directly on the other element or intervening elements may be present therebetween. In contrast, when an element is referred to as being “directly on” another element, there are no intervening elements present.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. Thus, reference to “an” element in a claim followed by reference to “the” element is inclusive of one element and a plurality of the elements. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A sound-absorbing material comprising:
a foam; and
sound-absorbing particles fixed directly to surfaces of cells walls in the foam.

2. The sound-absorbing material of claim 1, wherein the sound-absorbing particles comprise a zeolite.

3. The sound-absorbing material of claim 1, wherein the foam comprises a silicone foam.

4. The sound-absorbing material of claim 1, wherein the foam comprises a polyurethane foam.

5. The sound-absorbing material of claim 1, wherein the foam comprises open cells.

6. The sound-absorbing material of claim 1, wherein the foam comprises open cells and closed cells.

7. The sound-absorbing material of claim 1, wherein the sound-absorbing material comprises less than 1 weight percent of binder, based on a total weight of the sound-absorbing material.

8. The sound-absorbing material of claim 1, wherein the sound-absorbing material comprises 0 weight percent of binder, based on a total weight of the sound-absorbing material.

9. The sound-absorbing material of claim 1, wherein the sound-absorbing material comprises less than 1 weight percent of adhesive, based on a total weight of the sound-absorbing material.

10. The sound-absorbing material of claim 1, wherein the sound-absorbing material comprises 0 weight percent of adhesive, based on a total weight of the sound-absorbing material.

11. An electronic device comprising:
a cavity; and
the sound-absorbing material of claim 1 disposed within the cavity.

12. The electronic device of claim 11, wherein the electronic device comprises a speaker.

13. A method of forming a sound-absorbing material comprising:
partially curing a curable foam composition to provide a partially cured foam composition;
contacting sound-absorbing particles and a surface of the partially cured foam composition to provide an intermediate foam product comprising the sound-absorbing particles directly on the surface of the partially cured foam composition; and
further curing the intermediate foam product to form the sound-absorbing material comprising a foam and the sound-absorbing particles fixed directly to surfaces of cell walls in the foam.

14. The method of claim 13, wherein contacting the sound-absorbing particles and the surface of the partially cured foam composition comprises use of a solvent carrier.

15. The method of claim 14, wherein the solvent carrier comprises hexamethyl disiloxane.

16. A method of forming an electronic device comprising:
forming a sound-absorbing material according to the method of claim 13; and
disposing the sound-absorbing material within a cavity of the electronic device.

17. A method of forming a sound-absorbing material comprising:
combining sound-absorbing particles and a solvent carrier to form a solution; and
contacting the solution and a surface of a foam composition to form a foam product comprising the sound-absorbing particles directly on a surface of the foam composition,
wherein the sound-absorbing material comprises less than 1 weight percent of binder, based on a total weight of the sound-absorbing material, and
wherein the sound-absorbing material comprises less than 1 weight percent of adhesive, based on a total weight of the sound-absorbing material.

18. The method of claim 17, wherein:
the method further comprises partially curing a curable foam composition to provide a partially cured foam composition;
contacting the sound-absorbing particles in the solvent carrier and the surface of the foam composition comprises contacting the sound-absorbing particles in the solvent carrier and the surface of the partially cured foam composition; and
the method further comprises further curing the foam product to form the sound-absorbing material comprising a foam and the sound-absorbing particles fixed directly to surfaces of cell walls in the foam.

19. The method of claim 17, wherein the foam composition is fully cured.

20. A method of forming an electronic device comprising:
forming a sound-absorbing material according to the method of claim 17; and
disposing the sound-absorbing material within a cavity of the electronic device.
